(19) United States
(12) Patent Application Publication
(10) Pub. No.: US 2026/0094804 A1
(43) Pub. Date: Apr. 2, 2026

(54) METHOD OF MANUFACTURING ELECTRODE FOR LITHIUM SECONDARY BATTERY

(71) Applicant: SK ON CO., LTD., Seoul (KR)

(72) Inventors: Young Gil CHOI, Daejeon (KR); Kwang Ho JEONG, Daejeon (KR); Young Ju CHOI, Daejeon (KR)

(21) Appl. No.: 19/344,538

(22) Filed: Sep. 30, 2025

(30) Foreign Application Priority Data
Oct. 2, 2024 (KR) 10-2024-0133884

(51) Int. Cl. H01M 4/04; H01M 4/1393; H01M 4/62; H01M 4/66; H01M 10/052

(52) U.S. Cl. CPC H01M 4/0435; H01M 4/0404; H01M 4/0471; H01M 4/1393; H01M 4/623; H01M 4/663; H01M 4/667; H01M 4/668; H01M 10/052

(57) ABSTRACT

According to a method of manufacturing an electrode for lithium secondary battery according to the present disclosure, a current collector is heated through a heating unit, and the current collector and a solid-state electrode composition are rolled through a rolling roller to form an electrode active material layer on at least one surface of the current collector.

### CROSS-REFERENCE TO RELATED APPLICATION AND CLAIM OF PRIORITY

This application claims priority to Korean Patent Application No. 10-2024-0133884 filed on 2024 Oct. 2 in the Korean Intellectual Property Office (KIPO), the entire disclosure of which is incorporated by reference herein.

### TECHNICAL FIELD

The disclosure of this patent application relates to a method of manufacturing an electrode for lithium secondary battery.

### BACKGROUND

Secondary batteries are batteries that can be repeatedly charged and discharged. With the development of information and communication and display industries, the secondary batteries are widely applied as a power source for portable electronic communication devices, such as camcorders, mobile phones, and laptop PCs. In addition, battery packs including the secondary batteries have been recently developed and applied as a power source for eco-friendly vehicles, such as electric vehicles.

Examples of the secondary battery include a lithium secondary battery, a nickel-cadmium battery, and a nickel-hydrogen battery. Among these, because the lithium secondary battery has a high operating voltage and a high energy density per unit weight and is advantageous in terms of charging speed and weight reduction, the lithium secondary battery is actively being developed and applied.

As the application scope of the lithium secondary batteries has recently expanded, a method of manufacturing an electrode for lithium secondary battery with higher reliability and process stability is being developed. For example, a resistance and an adhesive strength of the electrode and life characteristics of the lithium secondary battery may deteriorate depending on a temperature of a manufacturing equipment and a composition of an electrode composition in a manufacturing process of the electrode.

### SUMMARY

According to an aspect of the present disclosure, there is provided a method of manufacturing an electrode for lithium secondary battery with improved driving reliability, output characteristics, and life characteristics.

According to embodiments of the present disclosure, there is provided a method of manufacturing an electrode for lithium secondary battery comprising preparing a solid-state electrode composition; heating a current collector through a heating unit; and rolling the current collector and the electrode composition through a rolling roller to form an electrode active material layer on at least one surface of the current collector.

In some embodiments, the rolling is performed after heating the current collector.

In some embodiments, a temperature of the rolling roller is lower than or equal to 25° C.

In some embodiments, the electrode composition includes an electrode active material, a first binder, and a second binder with a lower melting temperature than the first binder.

In some embodiments, the first binder includes polytetrafluoroethylene, and the second binder includes polyvinylidene fluoride.

In some embodiments, a shortest distance between the rolling roller and the heating unit is 5 cm to 50 cm.

In some embodiments, the heating unit includes at least one selected from a group consisting of an induction heating annealing unit, an infrared (IR) heating unit, and a hot air heating unit.

In some embodiments, before heating the current collector, a primer layer is formed on at least one surface of the current collector, and the electrode active material layer is formed on the primer layer.

In some embodiments, the electrode composition includes an electrode active material, a first binder, and a second binder with a lower melting temperature than the first binder, and the primer layer includes conductive carbon, a third binder, and a fourth binder with a higher glass transition temperature than the third binder.

In some embodiments, a heating temperature of the heating unit satisfies the following Equations 1 and 2:

$$Z = \frac{\frac{( W 1 * Tm 1 + W 2 * Tm 2 )}{3 * ( W 1 + W 2 )} + \frac{( W 3 * Tg 3 + W 4 * Tg 4 )}{( W 3 + W 4 )}}{2} \qquad [ Equation 1 ]$$

$$0.5 * Z \leq heating temperature \leq 1.3 * Z \qquad [ Equation 2 ]$$

In Equations 1 and 2, Z is an intermediate variable, W1 is an amount (wt %) of the first binder based on the total weight of the electrode composition, W2 is an amount (wt %) of the second binder based on the total weight of the electrode composition, W3 is an amount (wt %) of the third binder based on the total weight of the primer layer, W4 is an amount (wt %) of the fourth binder based on the total weight of the primer layer, Tm1 is a melting temperature of the first binder, Tm2 is a melting temperature of the second binder, Tg3 is a glass transition temperature of the third binder, and Tg4 is a glass transition temperature of the fourth binder.

In some embodiments, the third binder includes styrene-butadiene rubber, and the fourth binder includes polyvinyl pyrrolidone.

In some embodiments, the electrode for lithium secondary battery includes at least one of a cathode and an anode.

According to embodiments of the present disclosure, there is provided a lithium secondary battery including an electrode manufactured based on the manufacturing method.

Embodiments of the present disclosure can provide a method of manufacturing an electrode for lithium secondary battery that is environmentally friendly and cost-effective.

According to embodiments of the present disclosure, an electrode composition sheet can be stably attached to a current collector even when a rolling roller is in a cold state (e.g., below 25° C.). Accordingly, contamination, increased resistance, and deterioration of life characteristics of the electrode due to the high-temperature rolling roller can be prevented.

According to embodiments of the present disclosure, as the structural stability of the electrode is improved, contamination and resistance of the electrode can be reduced, and the life characteristics of the electrode can be improved.

A method of manufacturing an electrode for lithium secondary battery according to the present disclosure can be widely applied in green technology fields, such as electric vehicles, battery charging stations, and other battery-based solar power generation and wind power generation. In addition, the method of manufacturing the electrode for lithium secondary battery according to the present disclosure can be used in eco-friendly electric vehicles, hybrid vehicles, etc. to prevent climate change by suppressing air pollution and greenhouse gas emissions.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 is a flowchart schematically illustrating a method of manufacturing an electrode for lithium secondary battery according to embodiments.

FIG. 2 is a schematic diagram illustrating a process of manufacturing an electrode for lithium secondary battery according to embodiments.

FIGS. 3 and 4 are a plan view and a cross-sectional view schematically illustrating a lithium secondary battery according to embodiments, respectively.

### DETAILED DESCRIPTION OF THE EMBODIMENTS

Embodiments of the present disclosure provide a method of manufacturing an electrode for lithium secondary battery (hereinafter, abbreviated as an “electrode”). A lithium secondary battery including the electrode (hereinafter, abbreviated as a “secondary battery”) is also provided.

Reference will now be made in detail to embodiments of the disclosure, examples of which are illustrated in the accompanying drawings. However, the following description is merely an example and does not intend to limit embodiments of the disclosure to a specific implementation.

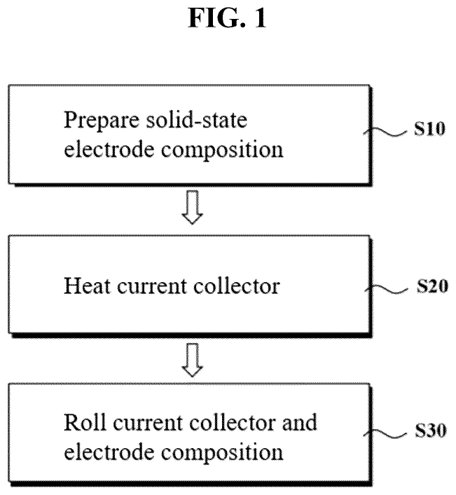

FIG. 1 is a flowchart schematically illustrating a method of manufacturing an electrode for lithium secondary battery according to embodiments.

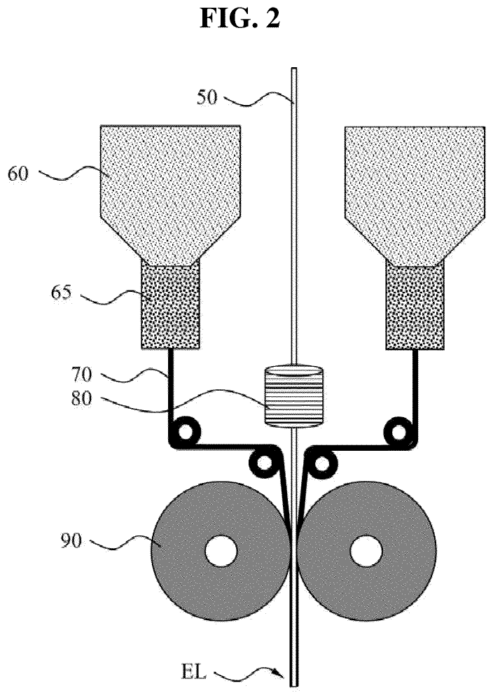

FIG. 2 is a schematic diagram illustrating a process of manufacturing an electrode for lithium secondary battery according to embodiments.

Referring to FIGS. 1 and 2, a solid-state electrode composition may be prepared (e.g., step S10).

For example, the solid-state electrode composition is eco-friendly because it does not contain a solvent, and a separate dryer is not required during a manufacturing process of the electrode, which can reduce the manufacturing cost of the electrode.

In some embodiments, the electrode composition may include an electrode active material, a first binder, and a second binder.

A melting temperature (Tm) of the second binder may be lower than a melting temperature of the first binder. Since the electrode composition includes two binders with different melting temperatures, chemical stability of the electrode composition can be improved and structural stability of the electrode can be improved.

In some embodiments, the first binder and/or the second binder may include polytetrafluoroethylene (PTFE), polyvinylidene fluoride (PVDF), hexafluoropropylene copolymer (FEP), tetrafluoroethylene-perfluoro (alkyl vinyl ether) copolymer (PFA), ethylene-tetrafluoroethylene copolymer (ETFE), poly(vinylidene fluoride-co-hexafluoropropylene (PVDFco-HFP), polyvinyl alcohol, polyacrylonitrile, carboxymethyl cellulose (CMC), starch, hydroxypropyl cellulose, regenerated cellulose, polyvinyl pyrrolidone, tetrafluoro ethylene, polyethylene, polypropylene, ethylene propylene diene polymer (EPDM), sulfonated-EPDM, styrene-butadiene rubber (SBR), poly(ethylene oxide) (PEO), or the like. These may be used alone or in combination of two or more.

In an embodiment, the first binder may include polytetrafluoroethylene (PTFE), and the second binder may include polyvinylidene fluoride (PVDF).

In some embodiments, the electrode may include at least one of a cathode and an anode. For example, the electrode active material may be a cathode active material or an anode active material.

For example, the cathode active material may include a compound capable of reversibly intercalating and deintercalating lithium ions.

According to embodiments, the cathode active material may include lithium-nickel metal oxide. The lithium-nickel metal oxide may include at least one of cobalt (Co), manganese (Mn), or aluminum (Al).

In some embodiments, the cathode active material or the lithium-nickel metal oxide may include a layered structure or crystal structure represented by the following Formula 1.

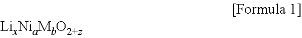

In Formula 1, 0.9≤x≤1.2, 0.6≤a≤0.99, 0.01≤b≤0.4, and −0.5≤z≤0.1. As described above, M may include Co, Mn and/or Al.

The chemical structure represented by Formula 1 represents a coupling relationship included in the layered structure or the crystal structure of the cathode active material and does not exclude other additional elements. For example, M may include Co and/or Mn, and Co and/or Mn may serve as a main active element of the cathode active material together with Ni. The Formula 1 is provided to express the coupling relationship of the main active elements and should be understood as a formula encompassing the introduction and substitution of additional elements.

In an embodiment, in addition to the main active elements, auxiliary elements may be further included to enhance the chemical stability of the cathode active material or the layered structure/crystal structure. The auxiliary elements may be incorporated into the layered structure/crystal structure to form a coupling. In this case, it should be understood that the auxiliary elements are also included within a chemical structure range represented by Formula 1.

For example, the auxiliary elements may include at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary elements may also act as an auxiliary active element that contributes to a capacity/output activity of the cathode active material, for example, together with Co or Mn as in Al.

For example, the cathode active material or the lithium-nickel metal oxide may include a layered structure or crystal structure represented by the following Formula 1-1.

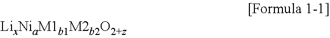

In Formula 1-1, M1 may include Co, Mn and/or Al. M2 may include the above-described auxiliary element. Further, 0.9≤x≤1.2, 0.6≤a≤0.99, 0.01≤b1+b2≤0.4, and −0.5≤z≤0.1.

The cathode active material may further include a coating element or a doping element. For example, elements substantially identical or similar to the above-described auxiliary elements may be used as the coating element or the doping element. For example, the above-described elements may be used alone or in combination of two or more as the coating element or the doping element.

The coating element or the doping element may be present on surfaces of lithium-nickel metal oxide particles or may penetrate through surfaces of lithium-nickel metal composite oxide particles. Hence, the coating element or the doping element may be included in the coupling structure represented by the Formula 1 or the Formula 1-1.

The cathode active material may include a nickel-cobalt-manganese (NCM)-based lithium oxide. In this case, an NCM-based lithium oxide with an increased nickel content may be used.

Ni may be provided as a transition metal associated with an output and a capacity of a lithium secondary battery. Therefore, a high-capacity cathode and a high-capacity lithium secondary battery may be provided by adopting a high-Ni composition to the cathode active material as described above.

However, as the Ni content increases, the long-term storage stability and life stability of the cathode or the secondary battery may relatively deteriorate, and a side reaction with an electrolyte may also increase. However, according to embodiments, the inclusion of Co may maintain electrical conductivity, and the inclusion of Mn may improve life stability and capacity retention characteristics.

A Ni content in the NCM-based lithium oxide (e.g., a mole fraction of nickel based on the total number of moles of nickel, cobalt, and manganese) may be 0.5 or more, 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a Li-rich layered oxide (LLO)/over lithiated oxide (OLO)-based active material, a Mn-rich-based active material, a Co-less-based active material, etc. having a chemical structure or a crystal structure represented by Formula 2. These may be used alone or in combination of two or more.

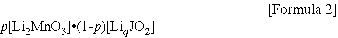

In Formula 2, 0<p<1, 0.9≤q≤1.2, and J may include at least one of Mn, Ni, Co, Fe, Cr, V, Cu, Zn, Ti, Al, Mg, or B.

For example, the anode active material may include a material capable of adsorbing and desorbing lithium ions. For example, the anode active material may include a carbon-based material such as crystalline carbon, amorphous carbon, carbon composites, and carbon fibers; lithium metal; lithium alloy; and silicon (Si)-containing material or tin (Sn)-containing material. These may be used alone or in combination of two or more.

The amorphous carbon may include hard carbon, soft carbon, coke, mesocarbon microbead (MCMB), mesophase pitch-based carbon fiber (MPCF), or the like.

The crystalline carbon may include a graphitic carbon such as natural graphite, artificial graphite, graphitized coke, graphitized MCMB, and graphitized MPCF.

The lithium metal may include pure lithium metal and/or lithium metal including a protective layer for suppressing dendrite growth, etc. In an embodiment, a lithium metal-containing layer deposited or coated on an anode current collector may be used as an anode active material layer. In an embodiment, a lithium thin film layer may be used as the anode active material layer.

Examples of elements included in the lithium alloy may include aluminum, zinc, bismuth, cadmium, antimony, silicon, lead, tin, gallium, indium, or the like. These may be used alone or in combination of two or more.

The Si-containing material may provide more increased capacity characteristics. The Si-containing material may include Si, SiOx (0<x<2), metal-doped SiOx (0<x<2), a silicon-carbon composite, etc.

The metal may include lithium and/or magnesium, and the metal-doped SiOx (0<x<2) may include a metal silicate.

In some embodiments, the electrode composition may further include a conductive material.

For example, the conductive material may be added to enhance conductivity of the electrode and/or mobility of lithium ions or electrons. For example, the conductive material may include a carbon-based conductive material such as conductive carbon, graphite, carbon black, acetylene black, Ketjen black, graphene, carbon nanotube (CNT), vapor-grown carbon fiber (VGCF), and carbon fibers, and/or a metal-based conductive material including a perovskite material such as tin, tin oxide, titanium oxide, LaSrCoO₃, and LaSrMnO₃. These may be used alone or in combination of two or more.

Referring to FIG. 2, in some embodiments, an electrode composition raw material including an electrode active material, a first binder, and a second binder may be fed into an inlet 60 of an electrode manufacturing device.

The electrode composition raw material may be transferred from the inlet 60 to a mixer 65 and mixed to prepare a solid-state electrode composition.

The electrode composition may be extruded from the mixer 65 in the form of an electrode composition sheet 70.

In embodiments, a current collector 50 may be heated through a heating unit 80 (e.g., step S20).

In some embodiments, the current collector 50 may be preheated before the rolling to improve an adhesive strength between the current collector 50 and the electrode composition sheet 70, thereby suppressing an increase in contamination and resistance in a subsequent rolling process.

For example, the current collector 50 may include a cathode current collector or an anode current collector.

For example, the cathode current collector may include stainless steel, nickel, aluminum, titanium, or an alloy thereof. The cathode current collector may also include aluminum or stainless steel surface-treated with carbon, nickel, titanium, or silver. For example, a thickness of the cathode current collector may be 10 μm to 50 μm.

For example, the anode current collector may include copper foil, nickel foil, stainless steel foil, titanium foil, nickel foam, copper foam, a polymer substrate coated with a conductive metal, or the like. These may be used alone or in combination of two or more. For example, a thickness of the anode current collector may be 10 μm to 50 μm.

In some embodiments, the heating unit 80 may include at least one selected from the group consisting of an induction heating annealing (IHA) unit, an infrared (IR) heating unit, and a hot air heating unit.

For example, the IHA unit may include a heating unit of an induction heating manner using electromagnetic induction. Hence, the stability and efficiency of heating the current collector 50 can be improved.

For example, the current collector 50 may be heated while passing through the heating unit 80.

In embodiments, the current collector 50 and the electrode composition (e.g., the electrode composition sheet 70) may be rolled by a rolling roller 90 to form an electrode EL in which an electrode active material layer is arranged on at least one surface of the current collector 50 (e.g., step S30).

The rolling may be performed after preheating the current collector 50 by the heating unit 80. By preheating the current collector 50 before the rolling, the electrode composition sheet 70 can be stably attached to the current collector 50 even when the rolling roller 90 is in a cold state (e.g., 25° C. or lower). Accordingly, contamination, energy waste, increased resistance, and deterioration of life characteristics of the electrode due to the high-temperature rolling roller can be prevented.

In some embodiments, a temperature of the rolling roller 90 may be lower than or equal to 25° C. In an embodiment, the temperature of the rolling roller 90 may be 15° C. to 25° C. Hence, the temperature of the rolling roller 90 may be maintained below the room temperature, thereby reducing the cost of manufacturing the electrode and the resistance and contamination of the electrode, and improving the life characteristics of the electrode.

As illustrated in FIG. 2, the rolling roller 90 may include a pair of rolling roller units facing each other. For example, the rolling may be performed at a point where the pair of rolling roller units are closest to each other (e.g., a rolling point).

In some embodiments, a shortest distance between the rolling roller and the heating unit may be 5 cm to 50 cm.

In some embodiments, a shortest distance between the rolling point and the heating unit 80 may be 5 cm to 50 cm, and in one embodiment, may be 20 cm to 40 cm.

In embodiments, a primer layer may be formed on at least one surface of the current collector 50 before the current collector 50 is heated by the heating unit 80.

For example, the electrode active material layer may be formed on the primer layer.

For example, the primer layer may be arranged between the current collector 50 and the electrode composition sheet 70 to serve as an adhesive layer which more stably attaches the current collector 50 and the electrode composition.

In an embodiment, a thickness of the primer layer may be about 3 μm to 5 μm. Within the above range, the structural stability of the electrode EL may be further improved, and the output characteristics of the secondary battery may be maintained or improved.

In some embodiments, the primer layer may include conductive carbon, a third binder, and a fourth binder.

A glass transition temperature (Tg) of the fourth binder may be higher than a glass transition temperature of the third binder. The stability and reliability of the electrode can be improved and the resistance of the electrode can be reduced by including two types of binders with different glass transition temperatures.

In some embodiments, the third binder and/or the fourth binder may include styrene-butadiene rubber (SBR), polyvinyl pyrrolidone (PVP), carboxymethyl cellulose (CMC), polyethylene glycol (PEG), polypropylene glycol (PPG), or the like. These may be used alone or in combination of two or more.

According to an embodiment, the third binder may include styrene-butadiene rubber, and the fourth binder may include polyvinyl pyrrolidone.

In some embodiments, a heating temperature of the heating unit 80 may satisfy Equations 1 and 2 below.

$$Z = \frac{\frac{( W 1 * Tm 1 + W 2 * Tm 2 )}{3 * ( W 1 + W 2 )} + \frac{( W 3 * Tg 3 + W 4 * Tg 4 )}{( W 3 + W 4 )}}{2} \qquad [ Equation 1 ]$$

$$0.5 * Z \leq heating temperature \leq 1.3 * Z \qquad [ Equation 2 ]$$

In Equations 1 and 2, Z is an intermediate variable for convenience of calculation. W1 is an amount (wt %) of the first binder based on the total weight of the electrode composition. W2 is an amount (wt %) of the second binder based on the total weight of the electrode composition. W3 is an amount (wt %) of the third binder based on the total weight of the primer layer. W4 is an amount (wt %) of the fourth binder based on the total weight of the primer layer. Tm1 is a melting temperature of the first binder. Tm2 is a melting temperature of the second binder. Tg3 is a glass transition temperature of the third binder. Tg4 is a glass transition temperature of the fourth binder.

As shown in Equations 1 and 2, the heating temperature of the heating unit 80 may be controlled based on the amount and the melting temperature of the binders included in the electrode composition, and the amount and the glass transition temperature of the binders included in the primer layer.

Within the range of Equation 2, the current collector 50, the primer layer, and the electrode composition sheet 70 may be sufficiently attached to improve the structural stability of the electrode, thereby reducing contamination and resistance of the electrode and improving the life characteristics of the electrode.

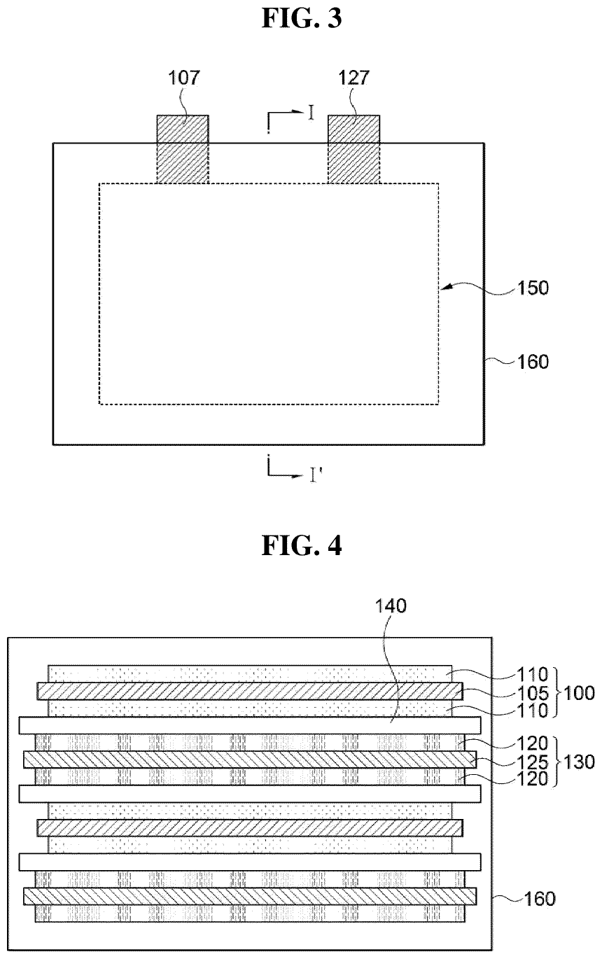

FIGS. 3 and 4 are a plan view and a cross-sectional view schematically illustrating a lithium secondary battery according to embodiments, respectively. For example, FIG. 4 is a cross-sectional view taken in a thickness direction along I-I′ of FIG. 3.

A lithium secondary battery may include an electrode manufactured based on the above-described manufacturing method. For example, the electrode may include an anode 130 or a cathode 100 facing the anode 130.

The cathode 100 may include a cathode current collector 105 and a cathode active material layer 110 that is formed on at least one surface of the cathode current collector 105 and includes the cathode active material described above.

The anode 130 may include an anode current collector 125 and an anode active material layer 120 that is formed on at least one surface of the anode current collector 125 and includes the anode active material described above.

In embodiments, a separator 140 may be interposed between the cathode 100 and the anode 130. The separator 140 may be configured to prevent an electrical short circuit between the cathode 100 and the anode 130 and to generate a flow of ions. For example, a thickness of the separator may be 10 μm to 20 μm.

For example, the separator 140 may include a porous polymer film or a porous non-woven fabric.

The porous polymer film may include a polyolefin polymer, such as an ethylene polymer, a propylene polymer, an ethylene/butene copolymer, an ethylene/hexene copolymer, and an ethylene/methacrylate copolymer. These may be used alone or in combination of two or more.

The porous nonwoven fabric may include high-melting-point glass fibers, polyethylene terephthalate fibers, or the like.

The separator 140 may also include a ceramic material. For example, inorganic particles may be coated on the polymer film or dispersed within the polymer film to improve a heat resistance.

The separator 140 may have a single-layer or multi-layer structure including the polymer film and/or the nonwoven fabric described above.

According to embodiments, an electrode cell may be defined by the cathode 100, the anode 130, and the separator 140, and a plurality of electrode cells may be stacked to form an electrode assembly 150 in the form of, for example, a jelly roll. For example, the electrode assembly 150 may be formed through winding, stacking, z-folding, stack-folding, etc. of the separator 140.

The electrode assembly 150 may be accommodated in a case 160 together with an electrolyte to define a lithium secondary battery. In embodiments, a non-aqueous electrolyte may be used as the electrolyte.

The non-aqueous electrolyte may include a lithium salt, which is an electrolyte, and an organic solvent. The lithium salt may be expressed as, for example, Li+X−. Examples of anion (X−) of the lithium salt may include F—, Cl—, Br—, I—, NO₃—, N(CN)₂—, BF₄—, ClO₄—, PF₆—, (CF₃)₂PF₄—, (CF₃)₃PF₃—, (CF₃)₄PF₂—, (CF₃)₅PF—, (CF₃)₆P—, CF₃SO₃—, CF₃CF₂SO₃—, (CF₃SO₂)₂N—, (FSO₂)₂N—, CF₃CF₂ (CF₃)₂CO—, (CF₃SO₂)₂CH—, (SF₅)₃C—, (CF₃SO₂)₃C—, CF₃ (CF₂)₇SO₃—, CF₃CO₂—, CH₃CO₂—, SCN—, (CF₃CF₂SO₂)₂N—, or the like.

Examples of the organic solvent may include propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propyl acetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, propylene sulfite, or the like. These may be used alone or in combination of two or more.

The non-aqueous electrolyte may further include an additive. Examples of the additive may include a cyclic carbonate compound, a fluorine-substituted carbonate compound, a sultone compound, a cyclic sulfate compound, a cyclic sulfite compound, a phosphate compound, a borate compound, or the like. These may be used alone or in combination of two or more.

The cyclic carbonate compound may include vinylene carbonate (VC), vinyl ethylene carbonate (VEC), or the like.

The fluorine-substituted carbonate compound may include fluoroethylene carbonate (FEC), or the like.

The sultone compound may include 1,3-propane sultone, 1,3-propene sultone, 1,4-butane sultone, or the like.

The cyclic sulfate compound may include 1,2-ethylene sulfate, 1,2-propylene sulfate, or the like.

The cyclic sulfite compound may include ethylene sulfite, butylene sulfite, or the like.

The phosphate compound may include lithium difluoro bis-oxalato phosphate, lithium difluoro phosphate, or the like.

The borate compound may include lithium bis(oxalate) borate, or the like.

In some embodiments, a solid electrolyte may be used instead of the above-described non-aqueous electrolyte. In this case, the lithium secondary battery may be manufactured in the form of an all-solid-state battery. In addition, a solid electrolyte layer instead of the above-described separator 140 may be arranged between the cathode 100 and the anode 130.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where m and n are a positive number, and Z is Ge, Zn or Ga), Li₂S—GeS₂, Li₂S—SiS₂—Li₃PO₄, Li₂S—SiS₂-LiₚMO_{q}, (where p and q are a positive number, and M is P, Si, Ge, B, Al, Ga, or In), Li₇-xPS₆-xClₓ (0≤x≤2), Li7-xPS₆-xBrₓ (0≤x≤2), Li₇-xPS₆-xIₓ (0≤x≤2), or the like. These may be used alone or in combination of two or more.

In an embodiment, the solid electrolyte may include, for example, an amorphous solid electrolyte such as Li₂O—B₂O₃—P₂O₅, Li₂O—SiO₂, Li₂O—B₂O₃, and Li₂O—B₂O₃—ZnO.

As illustrated in FIGS. 3 and 4, electrode tabs (a cathode tab and an anode tab) may respectively protrude from the cathode current collector 105 and the anode current collector 125 belonging to each electrode cell and may extend to one side of the case 160. The electrode tabs may be fused together with the one side of the outer case 160 to form electrode leads (a cathode lead 107 and an anode lead 127) that are extended or exposed to the outside of the outer case 160.

The lithium secondary battery may be manufactured, for example, in a cylindrical shape, a square shape, a pouch shape, a coin shape, etc., using a can.

Hereinafter, embodiments of the present disclosure are additionally described with reference to specific experimental examples. Embodiments and comparative examples included in the experimental examples are merely illustrative of the present disclosure and do not limit the scope of the appended claims. It will be apparent to those skilled in the art that various changes and modifications to the embodiments are possible within the scope and technical idea of the present disclosure, and it is also natural that such changes and modifications fall within the scope of the appended claims.

### Embodiment 1

### Electrode Manufacturing

A solid-state electrode composition raw material including a graphite-based active material mixed with artificial graphite and natural graphite in a weight ratio of 5:5 as an electrode active material, conductive carbon as a conductive material, PTFE as a first binder, and PVDF as a second binder in a weight ratio of 96:1:2(W1):1(W2) was put into an inlet of an electrode manufacturing device.

A melting temperature Tm1 of the PTFE was 320° C., and a melting temperature Tm2 of the PVDF was 175° C.

The electrode composition raw material was transferred from the inlet to a mixer and mixed to prepare a solid-state electrode composition.

The electrode composition was extruded from the mixer in the form of an electrode composition sheet.

A primer layer including conductive carbon, carboxymethyl cellulose (CMC), SBR as a third binder, and PVP as a fourth binder at a weight ratio of 48:4:24(W3):24(W4) was formed on a current collector (copper foil).

A glass transition temperature Tg3 of the SBR was 0° C., and a glass transition temperature Tg4 of the PVP was 150° C.

After a laminate of the current collector and the primer layer passed through an induction heating (IHA) unit heated to 41.4° C., the electrode composition sheet, the primer layer, and the current collector were rolled through rolling rollers heated to 25° C. to manufacture an electrode including an electrode active material layer arranged on two surfaces of the current collector.

A shortest distance between a closest point (rolling point) between a pair of rolling rollers and the IHA unit was 30 cm.

### Li-Half Cell Manufacturing

A Li-half cell including the electrode was manufactured using Li metal as a counter electrode.

Specifically, a Li coin half-cell of CR2016 (diameter of 20 mm and thickness of 1.6 mm) standard was constructed by interposing a separator (polyethylene, 20 μm thick) between the electrode and the Li metal (1 mm thick).

After a combination of the Li metal/separator/cathode was put into a coin cell plate and an electrolyte was poured into the coin cell plate, the coin cell plate was capped and clamped. The electrolyte used was prepared by adding 2.0 vol % of fluoroethylene carbonate (FEC) relative to the total volume of the electrolyte to a 1M LiPF₆ solution prepared using a mixed solvent of EC/EMC (volume ratio of 3:7). After clamping, the combination was impregnated for 3 to 24 hours, and then 3 cycles of charge and discharge were performed at 0.1 C (charge conditions: CC-CV 0.1 C 0.01V 0.01 C CUT-OFF, discharge conditions: CC 0.1 C 1.5V CUT-OFF).

### Embodiments 2 to 17

An electrode and a Li-half cell were manufactured in the same manner as the embodiment 1, except that a weight ratio of an electrode composition, a weight ratio of a primer layer, a shortest distance between a rolling point and an IHA unit, and a heating temperature of the IHA unit were adjusted as shown in Table 1.

### Comparative Example 1

An electrode and a Li-half cell were manufactured in the same manner as the embodiment 1, except that a current collector did not pass through an IHA unit.

### Comparative Example 2

An electrode and a Li-half cell were manufactured in the same manner as the embodiment 1, except that a current collector did not pass through an IHA unit, and a rolling roller was heated to 41.4° C.

### Experimental Example

### (1) Adhesive Strength Measurement

A magic tape manufactured by 3M was attached to the electrodes according to the embodiments and the comparative examples and was pressurized to remove air bubbles, and an adhesive strength between an electrode active material layer and a current collector was measured using DS2-500N manufactured by IMADA Co., Ltd.

### (2) Measurement of Bulk Resistance and Interfacial Resistance

Each of the electrodes according to the embodiments and the comparative examples was cut into 10 cm×10 cm size to produce a sample. The sample was placed in RM2610 manufactured by HIOKI to measure a bulk resistance and an interfacial resistance.

### (3) Direct Current Internal Resistance (DCIR) Measurement

The Li-half cells according to the embodiments and the comparative examples were discharged to SOC 50% of an initial discharge capacity at room temperature (25° C.), rested for 1 hour, discharged at 1 C for 10 seconds, and DCIR was measured based on the following measurement equation.

$$[ Measurement Equation ]$$

$$DCIR ( V 0 - V 1 ) / I$$

In the measurement equation, V0 is the voltage of the Li-half cell discharged to SOC 50% of the initial discharge capacity at room temperature (25° C.) and rested for 1 hour, V1 is the voltage of the Li-half cell discharged at 1 C for 10 seconds, and I is the 1 C current value.

### (4) Capacity Retention Rate Evaluation (500 Cycles)

For the Li-half cells according to the embodiments and the comparative examples, 500 cycles of charging (CC-CV 0.1 C 0.01V 0.01 C CUT-OFF) and discharging (CC 0.1 C 1.5V CUT-OFF) were performed at room temperature (25° C.). A capacity retention rate was evaluated by dividing a discharge capacity at 500 cycles by a discharge capacity at 1 cycle and multiplying by 100.

The measurement and evaluation results are shown in Table 2.

The weight ratio of the electrode composition (electrode active material:conductive carbon:first binder:second binder), the weight ratio of the primer layer (conductive carbon:CMC:third binder:fourth binder), the shortest distance between the rolling point and the IHA unit (‘shortest distance’ in Table 1), the heating temperature of the heating unit, Z value of Equations 1 and 2, and a ratio of the heating temperature to the Z value (‘Z ratio’ in Table 1) are shown in Table 1.

TABLE 1

| | Weight ratio of | | Shortest | Heating | | |
|---|---|---|---|---|---|---|
| | electrode | Weight ratio of | distance | temperature | | |
| | composition | primer layer | (cm) | (° C.) | Z value | Z ratio |
| Embodiment 1 | 96:1:2:1 | 48:4:24:24 | 30 | 41.4 | 82.8 | 0.5 |
| Embodiment 2 | 96:1:2:1 | 48:4:12:36 | 30 | 81.2 | 101.5 | 0.8 |
| Embodiment 3 | 96:1:2:1 | 48:4:12:36 | 30 | 60.2 | 120.3 | 0.5 |
| Embodiment 4 | 96:1:2:1 | 48:4:0:48 | 30 | 120.3 | 120.3 | 1.0 |
| Embodiment 5 | 96:1:2:1 | 48:4:0:48 | 30 | 156.4 | 120.3 | 1.3 |
| Embodiment 6 | 97:1:2:0 | 48:4:48:0 | 30 | 21.3 | 53.3 | 0.4 |
| Embodiment 7 | 97:1:2:0 | 48:4:24:24 | 30 | 36.3 | 90.8 | 0.4 |
| Embodiment 8 | 97:1:2:0 | 48:4:24:24 | 30 | 136.2 | 90.8 | 1.5 |
| Embodiment 9 | 96:1:2:1 | 48:4:36:12 | 30 | 89.6 | 64.0 | 1.4 |
| Embodiment 10 | 96:1:2:1 | 48:4:0:48 | 30 | 36.1 | 120.3 | 0.3 |
| Embodiment 11 | 96:1:2:1 | 48:4:0:48 | 30 | 180.5 | 120.3 | 1.5 |
| Embodiment 12 | 96:1:2:1 | 48:4:24:24 | 5 | 41.4 | 82.8 | 0.5 |
| Embodiment 13 | 96:1:2:1 | 48:4:24:24 | 20 | 41.4 | 82.8 | 0.5 |
| Embodiment 14 | 96:1:2:1 | 48:4:24:24 | 40 | 41.4 | 82.8 | 0.5 |
| Embodiment 15 | 96:1:2:1 | 48:4:24:24 | 50 | 41.4 | 82.8 | 0.5 |
| Embodiment 16 | 96:1:2:1 | 48:4:24:24 | 3 | 41.4 | 82.8 | 0.5 |
| Embodiment 17 | 96:1:2:1 | 48:4:24:24 | 55 | 41.4 | 82.8 | 0.5 |
| Comparative | 96:1:2:1 | 48:4:24:24 | — | — | 82.8 | — |
| Example 1 | | | | | | |
| Comparative | 96:1:2:1 | 48:4:24:24 | — | — | 82.8 | — |
| Example 2 | | | | | | |

TABLE 2

| | Adhesive | Bulk | Interfacial | | Capacity |
|---|---|---|---|---|---|
| | strength | resistance | resistance | DCIR | retention rate |
| | (N/18 mm) | (mΩcm) | (mΩcm²) | (mΩ) | (%, 500 cyc) |
| Embodiment 1 | 0.46 | 55.4 | 42.6 | 1.106 | 94.1 |
| Embodiment 2 | 0.63 | 50.1 | 30.6 | 1.008 | 94.9 |
| Embodiment 3 | 0.59 | 47.8 | 35.9 | 1.026 | 95.6 |
| Embodiment 4 | 0.88 | 40.3 | 18.4 | 0.982 | 97.2 |
| Embodiment 5 | 0.90 | 41.5 | 18.0 | 0.982 | 96.8 |
| Embodiment 6 | 0.15 | 60.9 | 50.6 | 1.325 | 87.5 |
| Embodiment 7 | 0.23 | 60.3 | 50.0 | 1.301 | 87.9 |
| Embodiment 8 | 0.53 | 59.9 | 49.2 | 1.123 | 91.0 |
| Embodiment 9 | 0.42 | 56.8 | 48.3 | 1.119 | 92.8 |
| Embodiment 10 | 0.26 | 58.3 | 49.2 | 1.125 | 90.5 |
| Embodiment 11 | 0.55 | 60.0 | 50.5 | 1.168 | 89.5 |
| Embodiment 12 | 0.52 | 53.5 | 41.5 | 1.098 | 92.9 |
| Embodiment 13 | 0.49 | 54.4 | 42.1 | 1.102 | 93.8 |
| Embodiment 14 | 0.42 | 55.2 | 43.1 | 1.110 | 94.5 |
| Embodiment 15 | 0.39 | 55.8 | 43.5 | 1.114 | 93.8 |
| Embodiment 16 | 0.65 | 53.0 | 40.6 | 1.087 | 90.6 |
| Embodiment 17 | 0.33 | 58.1 | 47.8 | 1.134 | 94.5 |
| Comparative | 0.04 | 62.6 | 51.2 | 1.223 | 64.3 |
| Example 1 | | | | | |
| Comparative | 0.51 | 72.5 | 60.6 | 1.385 | 81.7 |
| Example 2 | | | | | |

Referring to Tables 1 and 2, in the embodiments in which the current collector was preheated by the heating unit before the rolling, the adhesive strength and the capacity retention rate were improved as a whole, and the resistance was reduced, compared to the comparative examples.

In the embodiments 6 to 11 in which the heating temperature was out of the range of Equation 2 (the Z ratio of 0.5 to 1.3 in Table 1), the adhesive strength and the capacity retention rate were relatively reduced, and the resistance was increased, compared to the other embodiments.

In the embodiment 16 in which the shortest distance between the rolling point and the heating unit was less than 5 cm, the capacity retention rate was relatively reduced compared to the embodiment 1 in which other conditions are the same.

In the embodiment 17 in which the shortest distance between the rolling point and the heating unit exceeded 50 cm, the adhesive strength was relatively reduced, and the resistance was relatively increased, compared to the embodiment 1 in which other conditions are the same.

What is claimed is:

1. A method of manufacturing an electrode for lithium secondary battery, comprising:
preparing a solid-state electrode composition;
heating a current collector through a heating unit; and
rolling the current collector and the electrode composition through a rolling roller to form an electrode active material layer on at least one surface of the current collector.

2. The method of manufacturing an electrode for lithium secondary battery according to claim 1, wherein the rolling is performed after heating the current collector.

3. The method of manufacturing an electrode for lithium secondary battery according to claim 1, wherein a temperature of the rolling roller is lower than or equal to 25° C.

4. The method of manufacturing an electrode for lithium secondary battery according to claim 1, wherein the electrode composition includes an electrode active material, a first binder, and a second binder with a lower melting temperature than the first binder.

5. The method of manufacturing an electrode for lithium secondary battery according to claim 4, wherein the first binder includes polytetrafluoroethylene, and the second binder includes polyvinylidene fluoride.

6. The method of manufacturing an electrode for lithium secondary battery according to claim 1, wherein a shortest distance between the rolling roller and the heating unit is 5 cm to 50 cm.

7. The method of manufacturing an electrode for lithium secondary battery according to claim 1, wherein the heating unit includes at least one selected from a group consisting of an induction heating annealing unit, an infrared (IR) heating unit, and a hot air heating unit.

8. The method of manufacturing an electrode for lithium secondary battery according to claim 1, wherein before heating the current collector, a primer layer is formed on at least one surface of the current collector, and
wherein the electrode active material layer is formed on the primer layer.

9. The method of manufacturing an electrode for lithium secondary battery according to claim 8, wherein the electrode composition includes an electrode active material, a first binder, and a second binder with a lower melting temperature than the first binder, and
wherein the primer layer includes conductive carbon, a third binder, and a fourth binder with a higher glass transition temperature than the third binder.

10. The method of manufacturing an electrode for lithium secondary battery according to claim 9, wherein a heating temperature of the heating unit satisfies the following Equations 1 and 2:
$$Z = \frac{\frac{( W 1 * Tm 1 + W 2 * Tm 2 )}{3 * ( W 1 + W 2 )} + \frac{( W 3 * Tg 3 + W 4 * Tg 4 )}{( W 3 + W 4 )}}{2} \qquad [ Equation 1 ]$$
$$0.5 * Z \leq heating temperature \leq 1.3 * Z \qquad [ Equation 2 ]$$
in Equations 1 and 2, where Z is an intermediate variable,
W1 is an amount (wt %) of the first binder based on the total weight of the electrode composition,
W2 is an amount (wt %) of the second binder based on the total weight of the electrode composition,
W3 is an amount (wt %) of the third binder based on the total weight of the primer layer,
W4 is an amount (wt %) of the fourth binder based on the total weight of the primer layer,
Tm1 is a melting temperature of the first binder,
Tm2 is a melting temperature of the second binder,
Tg3 is a glass transition temperature of the third binder, and
Tg4 is a glass transition temperature of the fourth binder.

11. The method of manufacturing an electrode for lithium secondary battery according to claim 9, wherein the third binder includes styrene-butadiene rubber, and the fourth binder includes polyvinyl pyrrolidone.

12. The method of manufacturing an electrode for lithium secondary battery according to claim 1, wherein the electrode for lithium secondary battery includes at least one of a cathode and an anode.

13. A lithium secondary battery comprising an electrode manufactured based on a method of manufacturing an electrode for lithium secondary battery according to claim 1.
